(19) United States
(12) Patent Application Publication
(10) Pub. No.: US 2026/0154043 A1
(43) Pub. Date: Jun. 4, 2026

(54) System, Method, and Device for Automated Development, Testing and Deployment of Features

(71) Applicant: The Toronto-Dominion Bank, Toronto (CA)

(72) Inventor: Mohammad Kazem FARHANG KERMANI, Thornhill (CA)

(73) Assignee: The Toronto-Dominion Bank, Toronto, ON (CA)

(21) Appl. No.: 18/964,211

(22) Filed: Nov. 29, 2024

(51) Int. Cl. G06F 8/30; G06F 8/60

(52) U.S. Cl. CPC G06F 8/30; G06F 8/60

(57) ABSTRACT

A system and method for automating feature development. The method includes providing a structured input form to obtain feature descriptions according to a set of criteria; analyzing the feature descriptions to generate a schema for executing the features in a user interface provided by an application; generating a database to store data utilized in executing features using the application and the user interface; enabling a prototype of the user interface to be automatically generated; utilizing machine learning to generate executable code for executing the features according to the prototype; and enabling the prototype to be interacted with to create a deployable application comprising the features.

### TECHNICAL FIELD

The following generally relates to development of features and, more particularly to automated development, testing and deployment of such features, for example, in software development.

### BACKGROUND

Generating prototypes for software products can be time consuming and difficult and, typically, various professionals with specialized skills are required. The process of prototyping may also inherently run contrary to existing software development, which requires detailed resource and access allocations to be made through deliberative processes and various approvals. In existing organizations, a prototype can be expected to take a week or longer to generate given the coordination and resource management required.

For example, typical software application development includes the coordination between a software developer, a tester, a database engineer, etc.

The various disciplines required to generate software products also create challenges in prototyping as each discipline operates according to their own policies. Each discipline can use a different language, adhere to their particular nomenclature, use their preferred syntax, etc. More democratic, faster, more robust, and/or more transparent prototyping is desirable.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example configuration of an application development environment.

FIG. 3 is a block diagram of an example configuration of an enterprise system.

FIG. 4 is a flow diagram illustrating example operations performed by a feature development engine.

FIG. 5 is a block diagram of an example configuration of a feature development engine.

FIG. 6 illustrates a structured input form to obtain feature descriptions according to a set of criteria.

FIG. 7 illustrates an example of a completed input form for a set of two features.

FIG. 8 illustrates a function table for the features shown in FIG. 7.

FIG. 9 illustrates an example of an automatically generated database used to support the features shown in FIG. 7.

FIG. 10 illustrates an example of an automatically generated user interface (UI) for a withdrawal feature.

FIG. 11 is a block diagram of an example configuration of a client device used to interface with, for example, the feature development engine.

FIG. 12 is a flow chart illustrating example operations that may be performed in automating feature development.

FIG. 13 is a flow chart illustrating example operations that may be performed in enabling a prototype to be interacted with to create a deployable application.

FIG. 14 is a flow chart illustrating example operations that may be performed in generating a database to store variables used to implement a set of functions.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It will also be appreciated that the use of singular terms such as “a” or “an,” in this description is not intended to be limited to instances of solely one object, unless explicitly recited as such. That is, for ease of reference and/or simplicity, the description, for example, may use the term “a” to represent a or multiple components. Similarly, the use of plural terminology, is not intended to limit this disclosure to aspects where multiple (as compared to singular) components are required. For example, “various servers” can refer to a single server, multiple servers of the same kind, or multiple servers of different kinds, etc.

Software applications typically include features that are generated based on desired actions, outcomes, outputs or other capabilities desired of the software application. The process of determining a desired feature to generating the features themselves can be time consuming and is normally mostly manual.

The following describes a feature development engine which may leverage tools such as machine learning to automate feature generation in software applications.

For example, using machine learning (ML) and access to a generative artificial intelligence (AI) large language model (LLM), the feature development engine may automatically parse a structured input form such as a “5WHI” table to generate a database and create screens or other functions that utilize the database in a short amount of time.

Certain example systems and methods described herein are able to automate feature development. In one aspect, there is provided a system for automating feature development, the system comprising: a processor; a communications module coupled to the processor; and a memory coupled to the processor. The memory stores computer executable instructions that when executed by the processor cause the system to:
provide a structured input form to obtain feature descriptions according to a set of criteria; analyze the feature descriptions to generate a schema for executing the features in a user interface provided by an application; generate a database to store data utilized in executing features using the application and the user interface; enable a prototype of the user interface to be automatically generated; utilize machine learning to generate executable code for executing the features according to the prototype; and
enable the prototype to be interacted with to create a deployable application comprising the features.

In certain example embodiments, the prototype is interacted with to generate at least one test case for the prototype using an editor module.

In certain example embodiments, the system further includes instructions to perform automated testing on the prototype according to the at least one test case.

In certain example embodiments, a deployment tool is provided to enable a tested application to be edited prior to deployment.

In certain example embodiments, the structured input form comprises at least two or more of the following elements: a syntax for an event that is desired via the prototype; entries for one or more of: why the event is occurring; one or more entities associated with the event; hardware on which the event occurs; and how the event should happen.

In certain example embodiments, the syntax for the event requires related entries to begin with a verb.

In certain example embodiments, other syntax requires entries associated with the one or more entities to define entities that have known information about them.

In certain example embodiments, the other syntax requires entries associated with the hardware on which the event occurs to comprise one of a plurality of pre-defined categories.

In certain example embodiments, to generate executable code to allocate one or more computer resources, the instructions cause the system to: determine functions of a plurality of functions required to implement the features; based on the determined functions, identify variables required to implement the determined functions; and generate the database to store the identified variables.

In certain example embodiments, to generate the executable code to allocate the one or more computer resources, the instructions cause the system to: provide interactive elements to receive one or more properties of the variables; wherein the generated database with the identified variables is populated with the received one or more properties.

In certain example embodiments, to generate the prototype of the user interface for the application, the instructions cause the system to: use machine learning to access a model to generate code for one or more graphical elements associated with one or more components of the user interface.

In certain example embodiments, the machine learning used to generate the code prompts a large language model (LLM) trained to generate executable code according to feature definitions.

In certain example embodiments, the application provides the features to execute operations related to user accounts, the user accounts having data stored in the generated database.

In another aspect, there is provided a method for automating feature development, the method comprising: providing a structured input form to obtain feature descriptions according to a set of criteria; analyzing the feature descriptions to generate a schema for executing the features in a user interface provided by an application; generating a database to store data utilized in executing features using the application and the user interface; enabling a prototype of the user interface to be automatically generated; utilizing machine learning to generate executable code for executing the features according to the prototype; and enabling the prototype to be interacted with to create a deployable application comprising the features.

In certain example embodiments, the prototype is interacted with to generate at least one test case for the prototype using an editor module.

In certain example embodiments, the method includes performing automated testing on the prototype according to the at least one test case.

In certain example embodiments, a deployment tool is provided to enable a tested application to be edited prior to deployment.

In certain example embodiments, the structured input form comprises at least two or more of the following elements: a syntax for an event that is desired via the prototype; entries for one or more of: why the event is occurring; one or more entities associated with the event; hardware on which the event occurs; and how the event should happen.

In certain example embodiments, to generate executable code to allocate one or more computer resources, the method comprises: determining functions of a plurality of functions required to implement the features; based on the determined functions, identifying variables required to implement the determined functions; and generating the database to store the identified variables.

In another aspect, there is provided a computer readable medium storing computer-executable instructions for automating feature development, the computer readable medium comprising computer executable instructions for: providing a structured input form to obtain feature descriptions according to a set of criteria; analyzing the feature descriptions to generate a schema for executing the features in a user interface provided by an application; generating a database to store data utilized in executing features using the application and the user interface; enabling a prototype of the user interface to be automatically generated; utilizing machine learning to generate executable code for executing the features according to the prototype; and enabling the prototype to be interacted with to create a deployable application comprising the features.

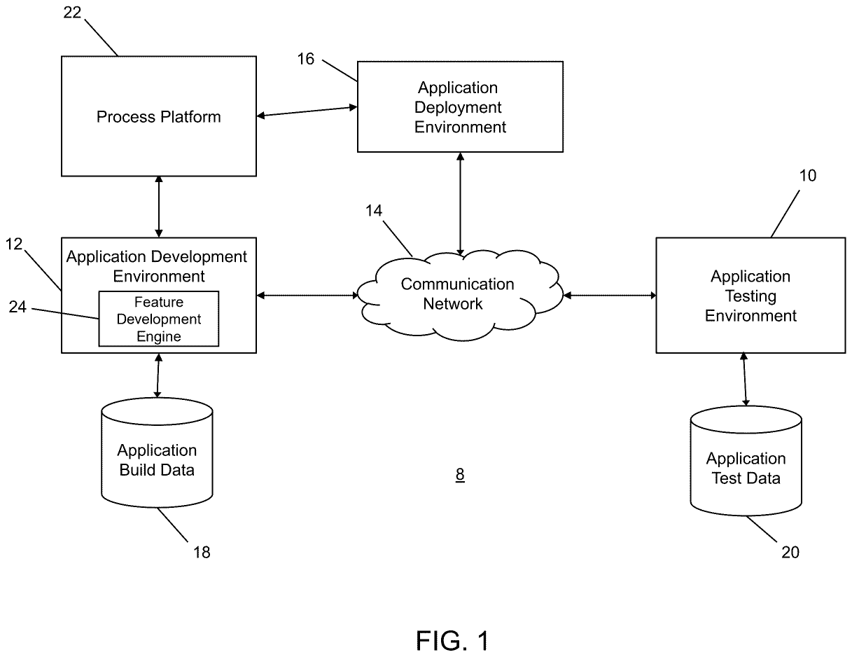

Referring now to the figures, FIG. 1 illustrates an exemplary computing environment 8. In this example, the computing environment 8 may include an application testing environment 10, an application development environment 12, and a communications network 14 connecting one or more components of the computing environment 8. The computing environment 8 may also include or otherwise be connected to an application deployment environment 16, which provides a platform, service, or other entity responsible for posting or providing access to applications that are ready for use by client devices.

The computing environment may also include or otherwise be connected to a process platform 22, which provides a platform, service or other entity responsible for designing, executing, and deploying process workflows (e.g., business or technical processes), whether separate from or in connection with an application developed in the application development environment 12. The application development environment 12 includes or is otherwise coupled to one or more repositories or other data storage elements for storing application build data 18. To enable automated and rapid prototyping of features in software development applications, the application development environment 12 may include or have access to a feature development engine 24. The feature development engine 24 may be utilized withing the application development environment 12 as shown in FIG. 1 or, additionally or alternatively, be utilized by other components of computing environment 8, e.g., the process platform 22.

As used herein a “build” may refer to the process of creating an application program for a software release, by taking all the relevant source code files and compiling them and then creating build artifacts, such as binaries or executable program(s), etc. “Build data” may therefore refer to any files or other data associated with a build. The terms “build” and “build data” (or “build file”) may also be used interchangeably to commonly refer to a version or other manifestation of an application, or otherwise the code or program associated with an application that can be tested for performance related metrics.

The application build data 18 can include any computer code and related data and information for an application to be deployed, e.g., for testing, execution or other uses. The application build data 18 can also include any computer code and related data and information for a business process workflow implemented by the process platform 22. In this example, the application build data 18 can be provided via one or more repositories and include the data and code required to perform application testing on a device or simulator.

The application testing environment 10 may include or otherwise have access to one or more repositories or other data storage elements for storing application test data 20, which includes any files, reports, information, results, metadata or other data associated with and/or generated during a test implemented within the application testing environment 10.

The computing environment 8 may be part of an enterprise or other organization that both develops and tests applications and/or designs and implements business process workflows. In such cases, the communication network 14 may not be required to provide connectivity between the application development environment 12, the application testing environment 10, and process platform 22, wherein such connectivity is provided by an internal network. The application development environment 12, application testing environment 10, and/or process platform 22, may also be integrated into the same enterprise environment as subsets thereof. That is, the configuration shown in FIG. 1 is illustrative only. Moreover, the computing environment 8 can include multiple enterprises or organizations, e.g., wherein separate organizations are configured to, and responsible for, application testing and application development, and/or business process workflows. For example, an organization may contract a third-party to develop an app for their organization but perform testing internally to meet proprietary or regulatory requirements. Similarly, an organization that develops an app may outsource the testing stages, particularly when testing is performed infrequently. The application deployment environment 16 may likewise be implemented in several different ways. For example, the deployment environment 16 may include an internal deployment channel for employee devices, may include a public marketplace such as an app store, or may include any other channel that can make the app available to clients, consumers or other users.

One example of the computing environment 8 may include a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc.

Users of applications or business processes described herein may be referred to as customers, clients, correspondents, or other entities that interact with the enterprise or organization associated with the computing environment 8 via one or more apps or workflows (which may employ one or more apps). Such users typically interact with the environment 8 using client communication devices. It may be noted that such client communication devices may be connectable to the application deployment environment 16, e.g., to download newly developed apps, to update existing apps, etc. In certain embodiments, a user may operate the client communication devices such that client device performs one or more processes consistent with what is being developed or tested in the disclosed embodiments. For example, the user may use client device to engage and interface with a mobile or web-based banking application which has been developed and tested within the computing environment 8 as herein described. In certain aspects, client communication devices can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication networks such as the communication network 14 shown by way of example in FIG. 1.

Communication network 14 may include a telephone network, cellular, and/or data communication network to connect different types of client devices. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

Referring back to FIG. 1, the computing environment 8 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the application development environment 12 and/or application testing environment 10. The cryptographic server may be used to protect data within the computing environment 8 (include the application build data 18 and/or application test data 20) by way of encryption for data protection, digital signatures or message digests for data integrity, and by using digital certificates to authenticate the identity of the users and entity devices with which the application development environment 12, process platform 22, and application testing environment 10 communicate to inhibit data breaches by adversaries. It can be appreciated that various cryptographic mechanisms and protocols can be chosen and implemented to suit the constraints and requirements of the particular deployment of the application development environment 12, process platform 22, and application testing environment 10 as is known in the art.

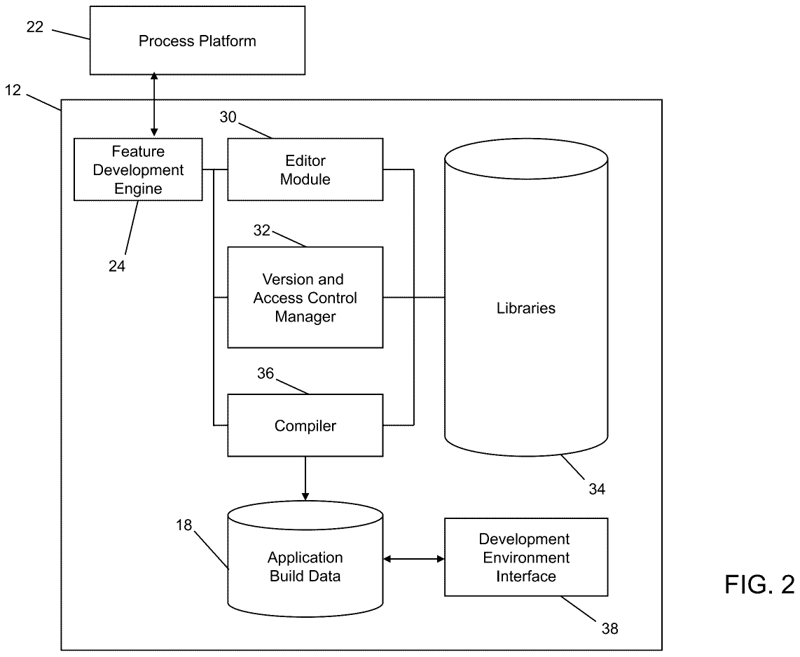

In FIG. 2, an example configuration of the application development environment 12 is shown. It can be appreciated that the configuration shown in FIG. 2 has been simplified for ease of illustration. In certain example embodiments, the application development environment 12 may include an editor module 30, a version and access control manager 32, one or more libraries 34, and a compiler 36, which would be typical components utilized in application development. In this example, the application development environment 12 also includes the application build data 18, which, while shown within the environment 12, may also be a separate entity (e.g., repository) used to store and provide access to the stored build files. The application development environment 12 also includes or is provided with (e.g., via an application programming interface (API)), a development environment interface 38. The development environment interface 38 provides communication and data transfer capabilities between the application development environment 12 and the application testing environment 10 from the perspective of the application development environment 12. As shown in FIG. 2, the development environment interface 38 can connect to the communication network 14 to send/receive data and communications to/from the application testing environment 10. For example, the testing environment interface 38 can be used to provide test results to the application development environment 12 based on testing conducted in the application testing environment 10.

The editor module 30 can be used by a developer/programmer to create and edit program code associated with an application being developed. This can include interacting with the version and access control manager 32 to control access to current build files and libraries 34 while enforcing permissions and version controls. The compiler 36 may then be used to compile an application build file and other data to be stored with the application build data 18. It can be appreciated that a typical application or software development environment 12 may include other functionality, modules, and systems, details of which are omitted for brevity and ease of illustration. It can also be appreciated that the application development environment 12 may include modules, accounts, and access controls for enabling multiple developers to participate in developing an application, and modules for enabling an application to be developed for multiple platforms. For example, a mobile application may be developed by multiple teams, each team potentially having multiple programmers. Also, each team may be responsible for developing the application on a different platform, such as Apple iOS or Google Android for mobile versions, and Google Chrome or Microsoft Edge for web browser versions. Similarly, applications may be developed for deployment on different device types, even with the same underlying operating system.

While not shown in FIG. 2 for clarity of illustration, in example embodiments, the application development environment 12 may be implemented using one or more computing devices such as terminals, servers, and/or databases, having one or more processors, communications modules, and database interfaces. Such communications modules may include the development environment interface 38, which enables the application development environment 12 to communicate with one or more other components of the computing environment 8, such as the application testing environment 10, via a bus or other communication network, such as the communication network 14. While not delineated in FIG. 2, the application development environment 12 (and any of its devices, servers, databases, etc.) includes at least one memory or memory device that can include a tangible and non-transitory computer-readable medium having stored therein computer programs, sets of instructions, code, or data to be executed by the one or more processors. FIG. 2 illustrates examples of modules, tools and engines stored in memory within the application development environment 12. It can be appreciated that any of the modules, tools, and engines shown in FIG. 2 may also be hosted externally and be available to the application development environment 12, e.g., via communications modules such as the development environment interface 38.

In this example embodiment, the application development environment 12 can include feature development engine 24 that can integrate or interface with the editor module 30 to enable features, tools, process workflows, etc., to be designed and integrated with an application that is being developed. The feature development engine 24 can also be connectable to the process platform 22 to allow business process workflows to communicate and/or integrate with application functionality both within an application or between multiple applications.

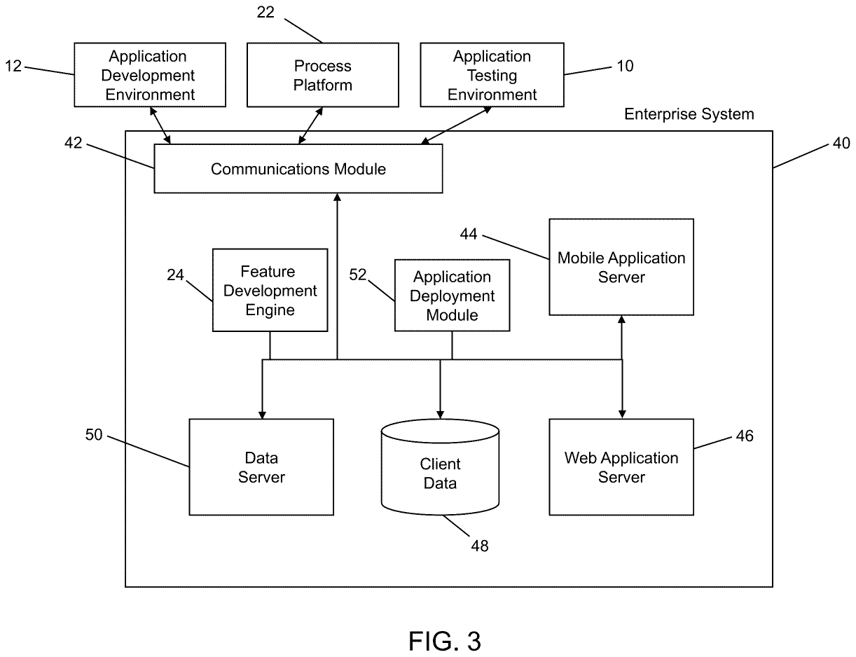

In FIG. 3, an example configuration of an enterprise system 40 is shown. The enterprise system 40 includes a communications module 42 that enables the enterprise system 40 to communicate with one or more other components of the computing environment 8, such as the application testing environment 10, process platform 22, or application development environment 12, via a bus or other communication network, such as the communication network 14. While not delineated in FIG. 3, the enterprise system 40 includes at least one memory or memory device that can include a tangible and non-transitory computer-readable medium having stored therein computer programs, sets of instructions, code, or data to be executed by one or more processors (not shown for clarity of illustration). FIG. 3 illustrates examples of servers and datastores/databases operable within the enterprise system 40. It can be appreciated that any of the components shown in FIG. 3 may also be hosted externally and be available to the enterprise system 40, e.g., via the communications module 42. In the example embodiment shown in FIG. 3, the enterprise system 40 includes one or more servers to provide access to client data 48, e.g., for development or testing purposes. Exemplary servers include a mobile application server 44, a web application server 46 and a data server 50. Although not shown in FIG. 3, as noted above, the enterprise system 40 may also include a cryptographic server for performing cryptographic operations and providing cryptographic services. The cryptographic server can also be configured to communicate and operate with a cryptographic infrastructure. The enterprise system 40 may also include one or more data storage elements for storing and providing data for use in such services, such as data storage for storing client data 48.

Mobile application server 44 supports interactions with a mobile application installed on client device (which may be similar or the same as a test device). Mobile application server 44 can access other resources of the enterprise system 40 to carry out requests made by, and to provide content and data to, a mobile application on client device. In certain example embodiments, mobile application server 44 supports a mobile banking application to provide payments from one or more accounts of user, among other things.

Web application server 46 supports interactions using a website accessed by a web browser application running on the client device. It can be appreciated that the mobile application server 44 and the web application server 46 can provide different front ends for the same application, that is, the mobile (app) and web (browser) versions of the same application. For example, the enterprise system 40 may provide a banking application that be accessed via a smartphone or tablet app while also being accessible via a browser on any browser-enabled device.

The client data 48 can include, in an example embodiment, financial data that is associated with users of the client devices (e.g., customers of the financial institution). The financial data may include any data related to or derived from financial values or metrics associated with customers of a financial institution system (i.e. the enterprise system 60 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

An application deployment module 52 is also shown in the example configuration of FIG. 3 to illustrate that the enterprise system 40 can provide its own mechanism to deploy the developed and tested applications onto client devices within the enterprise. It can be appreciated that the application deployment module 52 can be utilized in conjunction with a third-party deployment environment 16 such as an app store to have tested applications deployed to employees and customers/clients.

The feature development engine 24 is also shown within the enterprise system 40 in the example shown in FIG. 3.

It will be appreciated that only certain modules, applications, tools and engines are shown in FIGS. 2 and 3 for ease of illustration and various other components would be provided and utilized by the application development environment 12 and enterprise system 40, as is known in the art.

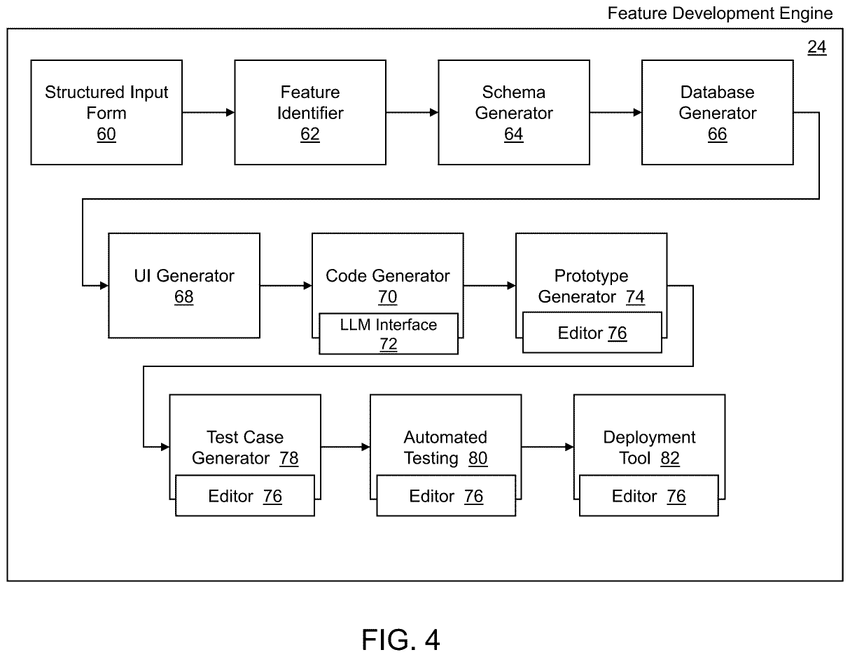

Referring now to FIG. 4, a flow diagram is illustrated within the feature development engine 24 to illustrate a sequence of stages that may be performed automatically, semi-automatically, or both, with certain manual inputs utilized.

At stage 60, a structured input form 60 is used to collect a predetermined set of data from a user or team of users, e.g., a 5WHI form or similar type of input form that enables the system to ingest a parseable set of data from which to automate at least one step in the UI, coding, testing and deployment processes. At stage 62, the structure input form 60 is analyzed by the engine 24 to apply feature identification. Once features are identified, they features are input to a schema generator at stage 64. The engine 24 may then also automatically generate a database at stage 66 to enable the engine 24 to access, for example, client data 48 that supports the operation of the application being prototyped.

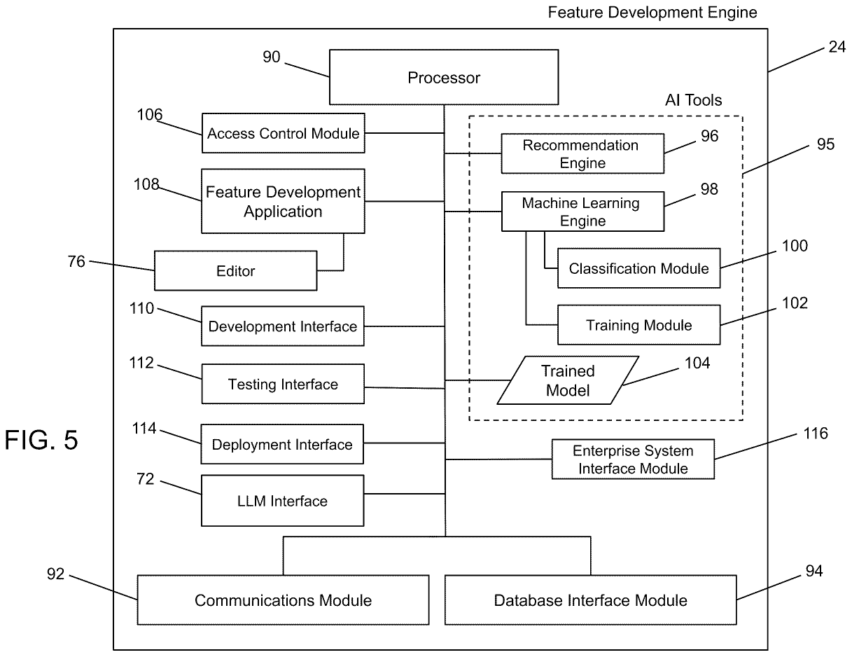

At stage 68, an ML engine 98 (see, for example, FIG. 5) may be used to automatically generate UI features by executing a UI generator. The UI generator at stage 68 may analyze the features identified at stage 62 to automatically classify the features such that corresponding stock UI features (e.g., input boxes, option selectors, etc.) may be accessed and added to a draft prototype UI canvas with minimal or no user input. With the UI generator having generated UI features at stage 68, the ML engine 98 may use an LLM interface 72 to have a GPT or other coding assistant generate draft computer code at stage 70. For example, basic building blocks of UI forms may be provided in a template database or modular code database that can be pulled and, with knowledge of the features and functions associated with the UI can have code snippets or modules pulled from outside sources or utilize the LLM interface 72 to have an LLM write the first draft of the code. The UI and code set may then be used at stage 74 for generating a prototype.

It can be appreciated that an editor 76 may be provided to allow for the prototype to be edited by users of the feature development engine 24. The editor 76 may be provided in various stages shown without limitation in FIG. 4. At stage 78, the generated (and possibly edited) prototype may be subjected to a test case generator. The test case generation process may access automated testing platforms, e.g., via the application development environment 12 and/or application testing environment 10 shown in FIG. 1.

With one or more test cases generated, the application prototype may be automatically tested at stage 80, e.g., as described above by accessing the application testing environment 10. In this way, the prototyping performed by the feature development engine 24 may be seamlessly integrated with end-to-end testing, development and deployment stages within an organization, e.g., the enterprise system 40.

At stage 82, a deployment tool may be used to access the application deployment environment 16 to have an application or feature within an application rapidly deployed. The feature development engine 24 may be used for rapid prototyping for urgent or timely campaign or temporary feature deployments to accommodate ephemeral feature usage and deployment within the computing environment 8.

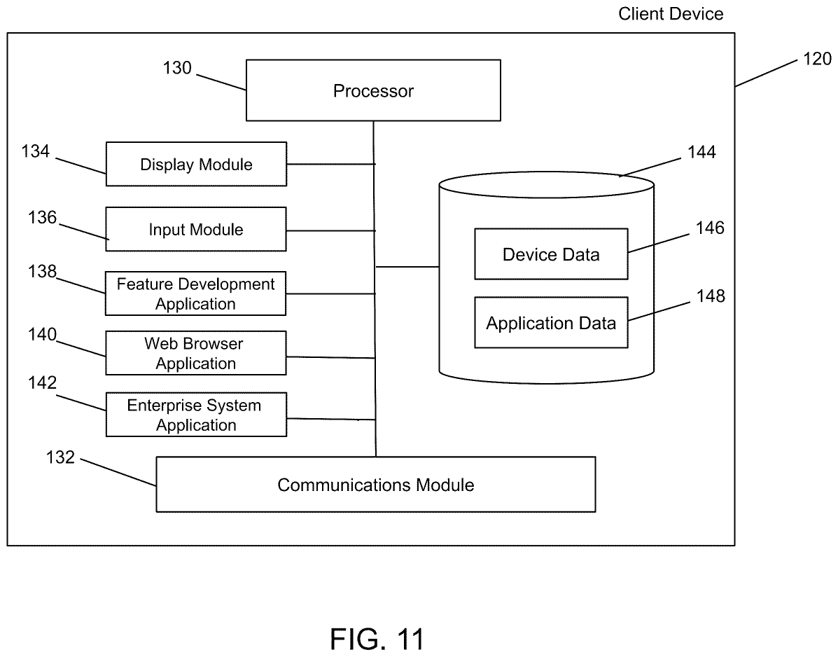

In FIG. 5, an example configuration of the feature development engine 24 is shown. In certain embodiments, the feature development engine 24 may include one or more processors 90, a communications module 92, and a database interface module 94 for interfacing with the datastores for the build data 18, test data 20, and any test repository, to retrieve, modify, and store (e.g., add) data. Communications module 92 enables the feature development engine 24 to communicate with one or more other components of the computing environment 8, such as client device 120 (or one of its components - see FIG. 11), via a bus or other communication network, such as the communication network 14. While not delineated in FIG. 5, the feature development engine 24 includes at least one memory or memory device that can include a tangible and non-transitory computer-readable medium having stored therein computer programs, sets of instructions, code, or data to be executed by processor 90.

FIG. 5 illustrates examples of modules, tools and engines stored in memory on the feature development engine 24 and executed by the processor 90. It can be appreciated that any of the modules, tools, and engines shown in FIG. 5 may also be hosted externally and be available to the feature development engine 24, e.g., via the communications module 92. In the example embodiment shown in FIG. 5, the feature development engine 24 includes a suite or set of AI tools 95. The AI tools 95 include or otherwise have access to a recommendation engine 96, a machine learning engine 98, a classification module 100, a training module 102, and at least one trained model 104. The feature development engine 24 also includes an access control module 106 and a feature development application 108 having access to the editor 76. The feature development engine 24 also includes a development interface 110, a testing interface 112, a deployment interface 114, the LLM interface 72, and an enterprise system interface module 116.

The recommendation engine 96 is used by the AI tools 95 of the feature development engine 24 to generate one or more recommendations for the feature development engine 24 and/or a client device 120 that is/are related to generating UIs, generating code for such UIs, generating test cases, etc. It may be noted that a recommendation as used herein may refer to a prediction, suggestion, inference, association or other recommended identifier that can be used to generate a suggestion, notification, command, instruction or other data that can be viewed, used or consumed by the feature development engine 24. The recommendation engine 96 can access application test data 20, application build data 18 other data stored by in a test repository (e.g., test states) or other data and information, and apply one or more inference processes to generate the recommendation(s). The recommendation engine 96 may utilize or otherwise interface with the machine learning engine 98 to both classify data currently being analyzed to generate a suggestion or recommendation, and to train classifiers using data that is continually being processed and accumulated by the feature development engine 24. That is, the recommendation engine 96 can learn testing outcomes, testing failures (e.g., for self-healing) or other test-related metrics and revise and refine classifications, rules or other analytics-related parameters over time. For example, the trained model 104 can be updated and refined using the training module 102 as client devices 120 interact with the feature development engine 24 during various interactions to improve the AI/ML parameters and understanding of how testing is implemented, monitored, and fixed.

The machine learning engine 98 may also perform operations that classify the test and application data in accordance with corresponding classifications parameters, e.g., based on an application of one or more machine learning algorithms to the data or groups of the data (also referred to herein as “app content”, “test or testing content”, “application build requests” or “test results content”). The machine learning algorithms may include, but are not limited to, a one-dimensional, convolutional neural network model (e.g., implemented using a corresponding neural network library, such as Keras®), and the one or more machine learning algorithms may be trained against, and adaptively improved, using elements of previously classified profile content identifying suitable matches between content identified and potential actions to be executed. Subsequent to classifying the testing-related content or content being analyzed, the recommendation engine 96 may further process each element of the content to identify, and extract, a value characterizing the corresponding one of the classification parameters, e.g., based on an application of one or more additional machine learning algorithms to each of the elements of the chat-related content. By way of example, the additional machine learning algorithms may include, but are not limited to, an adaptive natural language processing (NLP) algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. Classification parameters may be stored and maintained using the classification module 100, and training data may be stored and maintained using the training module 102.

The trained model 104 may also be created, stored, refined, updated, re-trained, and referenced by the feature development engine 24 (e.g., by way of the AI tools 95) to determine associations between testing-related messages or commands, and suitable responses or actions, and/or content related thereto. Such associations can be used to generate recommendations or suggestions for improving testing procedures or application features being tested.

In some instances, classification data stored in the classification module 100 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between testing objectives and testing outcomes, and certain potential actions.

In some instances, the additional, or alternate, machine learning algorithms may include one or more adaptive, NLP algorithms capable of parsing each of the classified portions of the content and predicting a starting and ending index of the candidate parameter value within each of the classified portions. Examples of the adaptive, NLP algorithms include, but are not limited to, NLP models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of event data (e.g., a value or type of data being augmented with an event or workflow) and a single classification parameter and additionally, or alternatively, multiple classification parameters.

Based on the output of the one or more machine learning algorithms or processes, such as the one-dimensional, convolutional neural network model described herein, machine learning engine 98 may perform operations that classify each of the discrete elements of testing-related content as a corresponding one of the classification parameters, e.g., as obtained from classification data stored by the classification module 100.

The outputs of the machine learning algorithms or processes may then be used by the recommendation engine 96 to generate one or more suggested recommendations, instructions, commands, notifications, rules, or other instructional or observational elements that can be presented to the AI tools 95. The AI tools 95 may be used by any one or more of the stages shown in FIG. 4. Similarly, the AI tools 95 may use the LLM interface 72 to access third party sources such as GPT-type services that use their own LLMs.

Referring again to FIG. 7, the access control module 106 may be used to apply a hierarchy of permission levels or otherwise apply predetermined criteria to determine what testing data or other client/user, financial or transactional data can be shared with which entity in the computing environment 8. For example, the feature development engine 24 may have been granted access to certain sensitive user profile data for a user, which is associated with a certain client device 26 in the computing environment 8. Similarly, certain client data may include potentially sensitive information such as age, date of birth, or nationality, which may not necessarily be needed by the feature development engine 24 to execute certain actions (e.g., to more accurately determine the spoken language or conversational style of that user). As such, the access control module 106 can be used to control the sharing of certain client data or chat data, a permission or preference, or any other restriction imposed by the computing environment 8 or application in which the feature development engine 24 is used.

The feature development engine 24 in this example also includes the feature development application 108 which may be used to implement the stages described above in connection with FIG. 4 and which can also provide access to the editor 76. The development interface 110, testing interface 112, and deployment interface 114 are also shown in FIG. 5 which, as described above, can be used to integrate the feature development engine 24 with the application testing environment 10 while providing the ability to operate testing in parallel within different frameworks as well as between testing frameworks and obtain data and information to generate reports for a dashboard and/or to be shared between testing frameworks.

The feature development engine 24 may also include the enterprise system interface module 116 to provide a graphical user interface (GUI) or API connectivity to communicate with the enterprise system 40 (see FIG. 3) to obtain client data 48 for a certain user interacting with the feature development engine 24 or to access or communicate with other applications, platforms and personnel within the enterprise. It can be appreciated that the enterprise system interface module 116 may also provide a web browser-based interface, an application or “app” interface, a machine language interface, etc.

As illustrated in FIG. 5, the feature development engine 24 can be considered one or more devices having a processor 90, memory and a communications module 92 configured to work with, or as part of, the computing environment 8, to perform the operations described herein. It can be appreciated that the various elements of the feature development engine 24 are shown delineated as such in FIG. 5 for illustrative purposes and clarity of description and could be provided using other configurations and distribution of functionality and responsibilities.

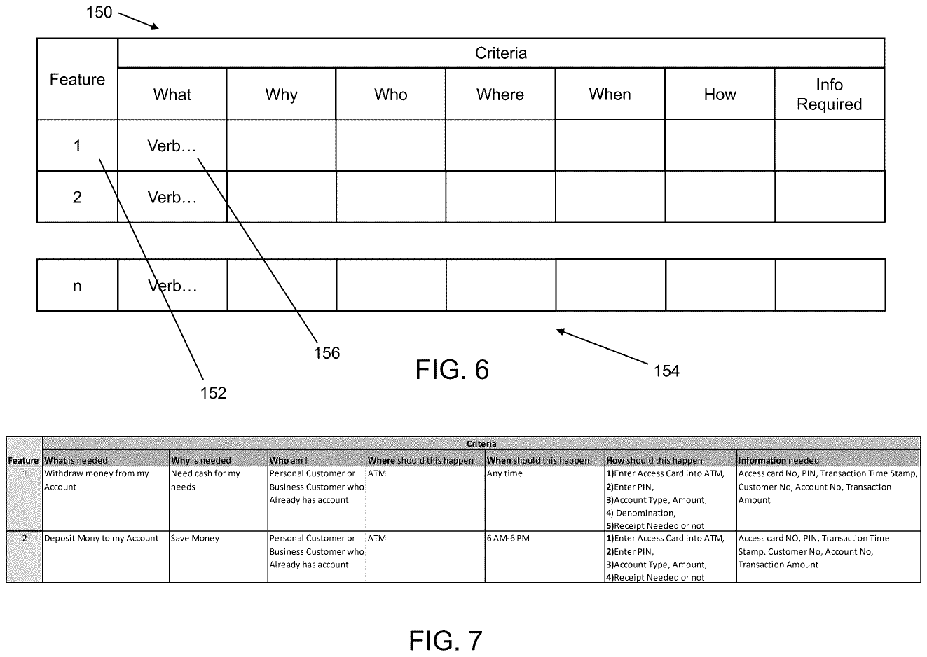

Referring now to FIGS. 6 through 10 an example use case showing feature development using the engine 24 is shown. Referring to FIG. 6, a structured input form 150 is provided, that enables a user (or group of users) to enter criteria 154 for a number of features 152 that they wish to prototype. In this example, the “what” criteria may be required to have a verb to assist the engine 24 in determining an action, event, or outcome associated with the feature 152. In this example, the so-called “5WHI” criteria 154, which are used in manual feature design may be leveraged. The 5Ws are What is needed, Why is it needed, Who am I, Where should this happen, and When should this happen. The “H” is How should this happen, and the “I” is the information needed. An example of two features sketched out by a user according to the 5WHI criteria is shown in FIG. 7.

The first feature, namely withdrawing money from an account includes a set of steps (How column) and information needed for executing those steps (I column). The second feature, namely depositing money also includes a set of steps and required info. By beginning the “What” column with a verb 156, an action can be detected from the table.

In an example scenario, assume a team is in a product meeting or story grooming session. The team fills out the 5WHI table for each feature with limited linguistic instruction such “start the what with a verb”.

In a short amount of time, e.g., during the meeting, an automated process can be executed by the feature development engine 24 to extract information from the table and automatically generate a feature that can be viewed and updated by the team, in near real-time, greatly speeding up the idea generation and execution process.

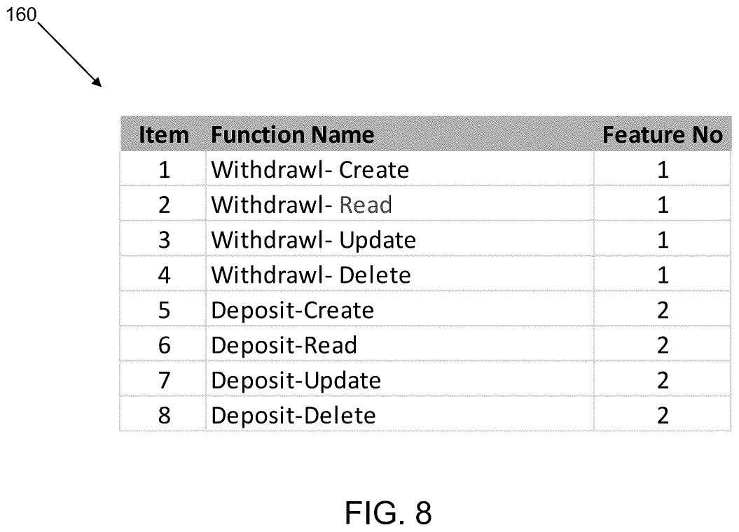

Using ML, the automated tool can extract a partial Schema (Table Name, Fields) from the 5WHI table above for each feature. New tables will not be added if the table is already identified as part of prior features. It also extracts function names as default of CRUD operations (Create, Read, Update, Delete). An example of a function name table 160 is shown in FIG. 8.

The field type and length may then be added to each field of the table from, for example, an existing organizational database. If one does not exist, default values can be added. By accessing an existing organizational database, the feature development engine 24 can generate features that can be more readily integrated into an existing system used by the team developing the feature.

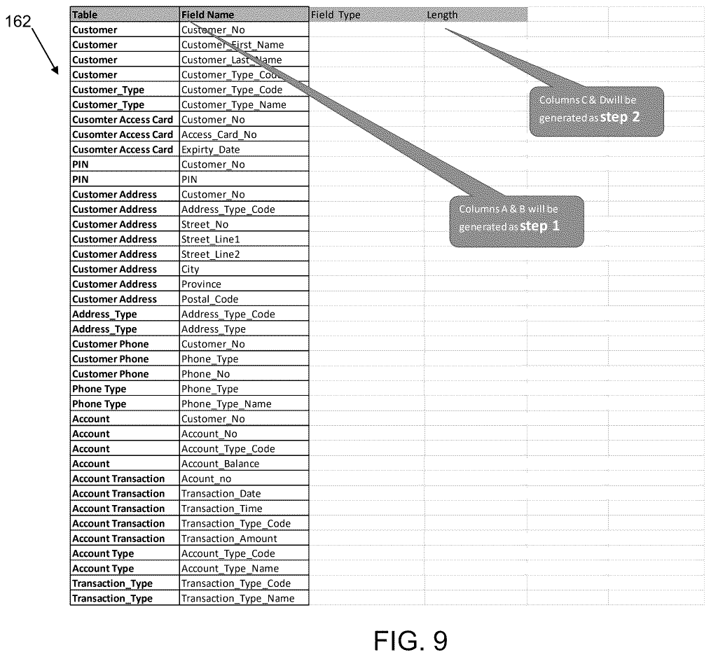

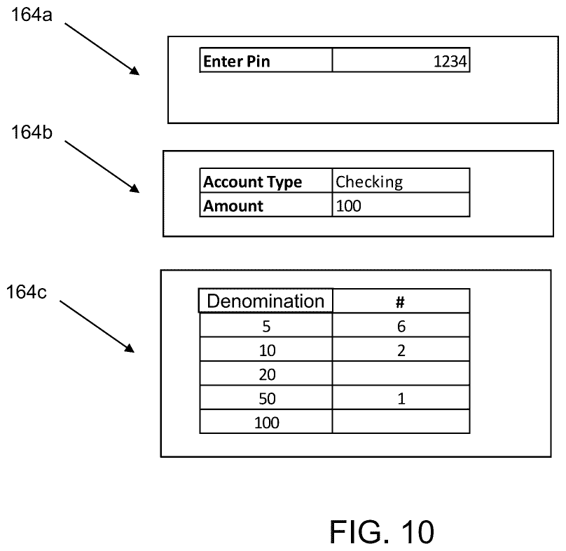

A schema is then built into a database of choice, e.g., Oracle, SQL server, etc.). Information associated with the database choice can come from a configuration file, e.g., one that specifies the database type, IP address, etc. An example of a schema 170 for the features in FIGS. 7-8 is shown in FIG. 9. Using ML, the feature development engine 24 may then design initial screens and a navigation sequence by parsing, for example, the H and I columns in the feature table. An example of the screens that may be generated, for illustrative purposes, is shown in FIG. 10. In this example a first screen 164a includes a PIN entry screen, a second screen 164b provides an account selection and amount entry screen. A third screen 164c may be presented to allow the user to select denominations for their withdrawal.

Then, using an API for a generative AI tool (e.g., LLM interface 72 to Chat GPT), the feature development engine 24 can prompt the associated LLM to generate the required code for each feature based on the completed previous steps using a selected or appropriate programming language. That is, the LLM may be used to stitch together the schema database and the screens using the functions and according to the information required and steps set out in the initial feature table. A prototype may then be launched and the team can quickly review and edit or configure from the baseline software application (or function within another application) to optimize the database and refine the features for testing, production, etc. The ML may also be leveraged at this time to automatically generate the minimum number of test cases to test the features based on the information from the 5WHI table as well as create an automated test case based on the previously described steps. These stages are illustrated in FIG. 4 and described above.

In FIG. 11, an example configuration of a client device 120 is shown. In certain embodiments, the client device 120 may include one or more processors 130, a communications module 132, and a data store 144 storing device data 146 and application data 148. Communications module 132 enables the client device 120 to communicate with one or more other components of the computing environment 8, such as the feature development engine 24, via a bus or other communication network, such as the communication network 14. While not delineated in FIG. 11, the client device 120 includes at least one memory or memory device that can include a tangible and non-transitory computer-readable medium having stored therein computer programs, sets of instructions, code, or data to be executed by processor 130. FIG. 11 illustrates examples of modules and applications stored in memory on the client device 120 and operated by the processor 130. It can be appreciated that any of the modules and applications shown in FIG. 11 may also be hosted externally and be available to the client device 120, e.g., via the communications module 132.

In the example embodiment shown in FIG. 11, the client device 120 includes a display module 134 for rendering GUIs and other visual outputs on a display device such as a display screen, and an input module 136 for processing user or other inputs received at the client device 120, e.g., via a touchscreen, input button, transceiver, microphone, keyboard, etc. The client device 120 may also include a feature development application 138, which may take the form of a customized app, plug-in, widget, or software component provided by the feature development engine 24 for use by the client device 120 to use feature development engine 24 and editor 76 as described above. Similarly, the client device 120 may include an enterprise system application 142 provided by the enterprise system 40. The client device 120 in this example embodiment also includes a web browser application 140 for accessing Internet-based content, e.g., via a mobile or traditional website. The data store 144 may be used to store device data 146, such as, but not limited to, an IP address or a MAC address that uniquely identifies client device 120 within environment 8. The data store 144 may also be used to store application data 148, such as, but not limited to, login credentials, user preferences, cryptographic data (e.g., cryptographic keys), etc.

It will be appreciated that only certain modules, applications, tools and engines are shown in FIGS. 1 to 5 and 11 for ease of illustration and various other components would be provided and utilized by the application testing environments 10, application development environment 12, feature development engine 24, test device, enterprise system 40, and client device 120 as is known in the art.

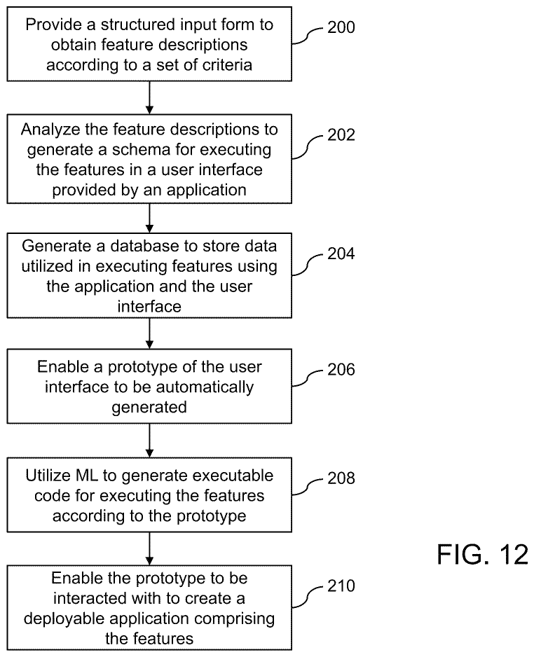

Referring now to FIG. 12, a flow chart illustrates operations that may be performed by the feature development engine 24 in automating feature development. At block 200, the feature development engine 24 provides a structured input form to obtain feature descriptions according to a set of criteria, e.g., as shown in FIGS. 6 and 7. At block 202, the feature development engine 24 analyzes the feature descriptions to generate a schema for executing the features in a user interface provided by an application, e.g., as shown in FIGS. 8 and/or 9.

At block 204, the feature development engine 24 generates a database to store data utilized in executing features using the application and the user interface, e.g., as shown in FIG. 9.

At block 206, the feature development engine 24 enables a prototype of the user interface to be automatically generated and, at block 208, utilizes ML to generate executable code for executing the features according to the prototype.

At block 210, the feature development engine 24 enables the prototype to be interacted with to create a deployable application comprising the features, e.g., using the editor module 30.

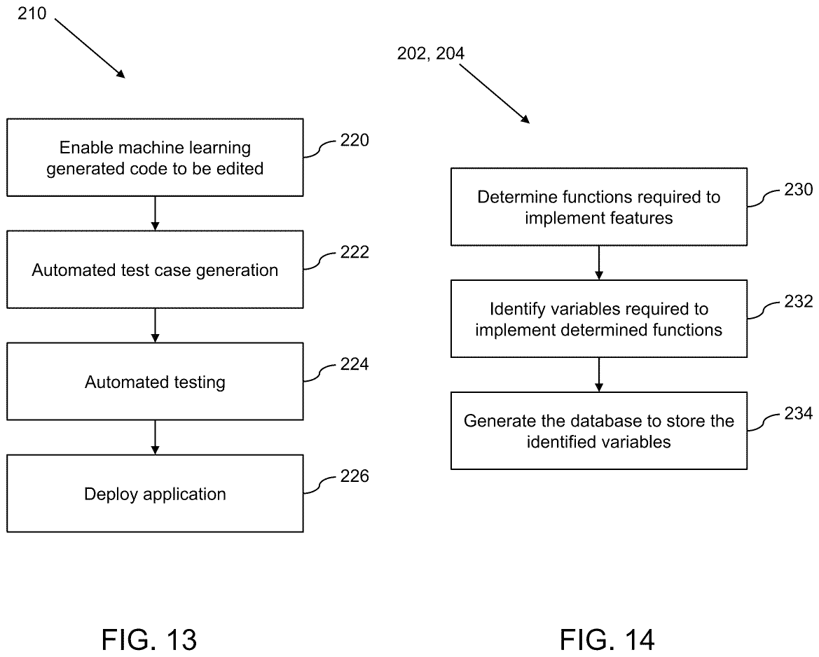

Referring to FIG. 13, a flow chart illustrates operations that may be performed by the feature development engine 24 in enabling the prototype to be interacted with to create a deployable application comprising the features (e.g. per block 210 in FIG. 12). At block 220 the feature development engine 24 enables ML generated code to be edited and, at block 222, automated test case generation to be executed. Then, at block 224, the feature development engine 24 enables automated testing such that an application can be deployed at block 226.

FIG. 14 provides a flow chart illustrates operations that may be performed by the feature development engine 24 in generating a schema and database for the prototype being developed. At block 230, the feature development engine 24 determines the functions required to implement the features. At block 232, the feature development engine 24 identifies the variables required to implement the determined functions, e.g., as shown in FIGS. 8 and 9. At block 234, the feature development engine 24 generates the database to store the identified variables 234, e.g., as illustrated in FIG. 9. This may include accessing client data 48 and other enterprise-held information and data. By having access within the enterprise system 40, the feature development engine 24 can further automate processes by automatically pulling data to enable prototyping, testing and deployment as described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 8, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A system for automating feature development, the system comprising:
a processor;
a communications module coupled to the processor; and
a memory coupled to the processor, the memory storing computer executable instructions that when executed by the processor cause the system to:
provide a structured input form to obtain feature descriptions according to a set of criteria;
analyze the feature descriptions to generate a schema for executing the features in a user interface provided by an application;
generate a database to store data utilized in executing features using the application and the user interface;
enable a prototype of the user interface to be automatically generated;
utilize machine learning to generate executable code for executing the features according to the prototype; and
enable the prototype to be interacted with to create a deployable application comprising the features.

2. The system of claim 1, wherein the prototype is interacted with to generate at least one test case for the prototype using an editor module.

3. The system of claim 2, further comprising computer executable instructions that when executed by the processor cause the system to:
perform automated testing on the prototype according to the at least one test case.

4. The system of claim 1, wherein a deployment tool is provided to enable a tested application to be edited prior to deployment.

5. The system of claim 1, wherein the structured input form comprises at least two or more of the following elements:
a syntax for an event that is desired via the prototype;
entries for one or more of:
why the event is occurring;
one or more entities associated with the event;
hardware on which the event occurs; and
how the event should happen.

6. The system of claim 5, wherein the syntax for the event requires related entries to begin with a verb.

7. The system of claim 6, wherein other syntax requires entries associated with the one or more entities to define entities that have known information about them.

8. The system of claim 7, wherein the other syntax requires entries associated with the hardware on which the event occurs to comprise one of a plurality of pre-defined categories.

9. The system of claim 1, wherein, to generate executable code to allocate one or more computer resources, the instructions cause the system to:
determine functions of a plurality of functions required to implement the features;
based on the determined functions, identify variables required to implement the determined functions; and
generate the database to store the identified variables.

10. The system of claim 9, wherein, to generate the executable code to allocate the one or more computer resources, the instructions cause the system to:
provide interactive elements to receive one or more properties of the variables;
wherein the generated database with the identified variables is populated with the received one or more properties.

11. The system of claim 1, wherein, to generate the prototype of the user interface for the application, the instructions cause the system to:
use machine learning to access a model to generate code for one or more graphical elements associated with one or more components of the user interface.

12. The system of claim 1, wherein the machine learning used to generate the code prompts a large language model (LLM) trained to generate executable code according to feature definitions.

13. The system of claim 1, wherein the application provides the features to execute operations related to user accounts, the user accounts having data stored in the generated database.

14. A method for automating feature development, the method comprising:
providing a structured input form to obtain feature descriptions according to a set of criteria;
analyzing the feature descriptions to generate a schema for executing the features in a user interface provided by an application;
generating a database to store data utilized in executing features using the application and the user interface;
enabling a prototype of the user interface to be automatically generated;
utilizing machine learning to generate executable code for executing the features according to the prototype; and
enabling the prototype to be interacted with to create a deployable application comprising the features.

15. The method of claim 14, wherein the prototype is interacted with to generate at least one test case for the prototype using an editor module.

16. The method of claim 15, further comprising:
performing automated testing on the prototype according to the at least one test case.

17. The method of claim 14, wherein a deployment tool is provided to enable a tested application to be edited prior to deployment.

18. The method of claim 14, wherein the structured input form comprises at least two or more of the following elements:
a syntax for an event that is desired via the prototype;
entries for one or more of:
why the event is occurring;
one or more entities associated with the event;
hardware on which the event occurs; and
how the event should happen.

19. The method of claim 14, wherein, to generate executable code to allocate one or more computer resources, the method comprises:
determining functions of a plurality of functions required to implement the features;
based on the determined functions, identifying variables required to implement the determined functions; and
generating the database to store the identified variables.

20. A non-transitory computer readable medium storing computer-executable instructions for automating feature development, the computer readable medium comprising computer executable instructions for:
providing a structured input form to obtain feature descriptions according to a set of criteria;
analyzing the feature descriptions to generate a schema for executing the features in a user interface provided by an application;
generating a database to store data utilized in executing features using the application and the user interface;
enabling a prototype of the user interface to be automatically generated;
utilizing machine learning to generate executable code for executing the features according to the prototype; and
enabling the prototype to be interacted with to create a deployable application comprising the features.
